(19) United States
(12) Patent Application Publication
(10) Pub. No.: US 2021/0245827 A1
(43) Pub. Date: Aug. 12, 2021

(54) Protective bar cap

(71) Applicant: Loam Lab Components Ltd., Squamish (CA)

(72) Inventor: Mark William Haimes, Garbaldi Highlands (CA)

(73) Assignee: Loam Lab Components Ltd., Squamish (CA)

(21) Appl. No.: 17/168,534

(22) Filed: Feb. 5, 2021

Related U.S. Application Data
(60) Provisional application No. 62/970,870, filed on Feb. 6, 2020.

(51) Int. Cl. B62J 23/00

(52) U.S. Cl. CPC B62J 23/00

(57) ABSTRACT

A protective bar cap that is connectable to a handlebar of a vehicle may include a base that includes an inboard side, an opposing outboard side that is spaced from the inboard side in a lateral direction, and a base length. A guard portion may extend longitudinally from the base between a guard root and a guard tip and defining a guard length that is between 25% and 200% of the base length. The guard tip may be positioned so that an inner surface of the guard portion is generally concave and laterally bounds a finger recess that is disposed longitudinally between the base and the guard tip. When the protective bar cap is connected to the handlebar the inboard side of the base engages the end of the handlebar and a finger of a vehicle rider can be at least partially laterally received within the finger recess.

### CROSS-REFERENCE TO RELATED APPLICATION

This application claims the benefit of co-pending, U.S. provisional patent application No. 62/970,870, filed Feb. 6, 2020 and entitled Protective Bar Cap, the entirety of which is incorporated herein by reference.

### FIELD OF THE INVENTION

The teachings of this application are directed to an accessory that can be connected to the handle bars of a bicycle, and specifically an accessory that can help protect the fingers/hand of a bicycle rider.

### INTRODUCTION

U.S. Pat. No. 3,832,912 discloses a handlebar safety shield fitted about the gripping control surfaces of a motorcycle handlebar in a manner to provide a protective shield for the hands of the motorcycle operator and to the hand controls of the motorcycle.

U.S. Patent publication no. 2016/0046343 discloses a handguard for a handle bar may include a body extending from a first contact point to a second contact point, a flexible member provided on the body, and a shock-absorbing member provided on the body. The flexible member and shock-absorbing member may be located at opposite ends of the body. The shock-absorbing member may include polyurethane. The shock-absorbing member may include a spring. The flexible member may be provided at the first contact point of the body and may include a rubber collar. The flexible member may be formed integral with the body and may include metal. The flexible member may be formed integral with the body and may include plastic. The flexible member may be integral to the handguard. The shock-absorbing member may be provided within the body at the second contact point of the body.

These devices are usually clamped inboard of the handlebar grip nearest to the thumb, as well as at the end of the handlebar. These devices can add an undesirable amount of weight to the handle bar, and they may crush and trap the hand inside the grip area in the event a collision deforms the device. Also, in the event the rider is ejected from the vehicle, the rider's hand may be caught by the device, possibly causing further injury. Furthermore, if the rider was to lose grip on the handle bar, their wrist and/or arm could slip down into the opening between the device and the hand grip, possibly causing injury. These devices may also be unappealing cosmetically to some riders.

U.S. Pat. No. 6,263,759 discloses a handlebar grip assembly which can be removably attached to a handlebar. The grip assembly when attached will not rotate around the handlebar in use, and yet is easily removed from the handlebar. The handlebar grip assembly has an inner rigid shell with outwardly extending protrusions at each end. A pair of rigid clamps pass over the outwardly extending protrusions and tighten against the handlebar to hold the grip assembly in place. A soft, flexible grip portion is affixed to the outer surface of the inner rigid shell.

This device is attached to the outer end of the handle bar, and is designed to provide additional leverage and alternative hand positions to the rider while in use. Accordingly, the device is sized and configured so as to be comfortable to grip and to withstand the expected steering and rider loads. The size of these devices can make it difficult for the rider to position his/her hand that the ends of the handle bar. Also, devices of this nature can be relatively heavy and can present the same type of crush and limb-trap safety risks as described above.

Accordingly, there remains a need for an improved accessory/protective bar cap device that can be attached to the handle bar of a vehicle and that can provide at least some protection to the fingers and/or hands of a rider from impact while at least reducing some of the disadvantages of known handle bar accessories.

### SUMMARY

This teachings herein relate, at least in part, to a novel handlebar attachment designed specifically for the purpose of preventing hand and finger injuries. This accessory, also referred to as a protective bar cap has a base that is configured to attach to the end of the handlebar, adjacent the hand grip portion, and has an extension or projection portion that protrudes outward from the front of the handlebar grip, so as to provide a physical barrier between at least the 5th digit of the rider's hand and a possible impact with an immoveable object such as a tree, posts, fences, branches, other vehicles and other such objects that may be contacted by the outer ends of the handle bar while the vehicle is in use.

The protective bar cap may be used on the handle bars of any suitable vehicle, including bicycles, motor cycles (including street motorcycles and off-road or “dirt bike” type motorcycles), snow mobiles, personal watercraft and the like. The teachings here refer to a bicycle when illustrating some embodiments of the protective bar cap, but analogous teachings can apply to the use of the protective bar cap on other vehicles.

For example, in the case of mountain biking, injuries to the metacarpal and metacarpal phalangeal joints of a rider from striking immoveable objects such as trees while the hands are on the handlebars are relatively common hand injuries. The Inventor has personally suffered two such 5th metacarpal fractures and one 5th digit fracture requiring surgical intervention in three separate incidents involving contact with trees while his hands were positioned correctly on the handlebars while riding a mountain bike.

The protective bar caps described herein are therefore configured to help provide at least some degree of physical/impact protection for the rider's hands, while optionally adding relatively little weight to the handlebar, having a relatively small overall size to help improve aesthetics and reduce the chances of the protective bar cap impeding the hand placement of the rider, having a relatively low risk of trapping a rider's hand or limbs during an accident, and having a relatively low risk of crushing a rider's fingers if the protective bar cap is deformed by impact.

In accordance with one broad aspect of the teachings described herein, a protective bar cap that is connectable to a handlebar of a vehicle may include a base that is connectable to an end of a handlebar of a vehicle. The base may include an inboard side, an opposing outboard side that is spaced from the inboard side in a lateral direction, and a base length in a longitudinal direction that is orthogonal to the lateral direction. A guard portion may extend longitudinally from the base between a guard root and a guard tip and may define a guard length that is between 25% and 200% of the base length. The guard tip may be positioned laterally inboard from the guard root so that an inner surface of the guard portion is generally concave and laterally bounds a finger recess that is disposed longitudinally between the base and the guard tip. When the protective bar cap is connected to the handlebar the inboard side of the base may engage the end of the handlebar and a finger of a vehicle rider can be at least partially laterally received within the finger recess.

The guard tip may be disposed laterally between the inboard and outboard sides of the base.

The guard tip may be laterally offset from the guard root by a tip offset distance that is between about 4 mm and about 15 mm

The guard tip may be disposed laterally inboard of the inboard side of the base by an inboard offset distance that is less than about 10 mm.

A lateral distance between the inboard and outboard sides of the base may define a base thickness and may be between about 5 mm and about 30 mm.

The guard length may be between about 30% and about 90% of the base length.

The guard length may be less than 40 mm, and may be less than 25 mm.

The root may have a root thickness in the lateral direction that is less than 20 mm, and the root thickness may be less 13 mm.

An outboard face of the guard portion may include an arcuate surface extending generally continuously from the guard root to the guard tip.

An outboard face of the guard portion may include two or more intersecting planar surfaces.

The base and the guard portion may be of integrally formed, one-piece construction.

The end of the handlebar may have a bar diameter and the base length maybe between about 80% and about 120% of the bar diameter.

The base may have a base height in a third direction that is orthogonal to the lateral and longitudinal directions. The guard portion may have a guard height in the third direction that is between 15% and 200% of the base height.

The guard height may be between 25% and 100% of the base height.

The outboard side of the base may include a substantially planar outer face that extends parallel to the longitudinal direction.

The substantially planar outer face may be co-planar with at least a portion of an outer face of the guard portion.

Other advantages of the invention will become apparent to those of skill in the art upon reviewing the present specification.

### BRIEF DESCRIPTION OF THE DRAWINGS

Embodiments of the present disclosure will be described with reference to the accompanying drawings, wherein like reference numerals denote like parts, and in which:

FIG. 1 is a perspective view of one example of a protective bar cap;

FIG. 2 is a perspective view of the protective bar cap of FIG. 1 connected to a handle bar;

FIG. 3 is a top view of the protective bar cap and handle bar of FIG. 2;

FIG. 4 is a cross-sectional view of the protective bar cap and handle bar of FIG. 2, taken along line 4-4;

FIG. 5 is a rear view of the protective bar cap of FIG. 1;

FIG. 6 is a front view of the protective bar cap of FIG. 1;

FIG. 7 is a top view of the protective bar cap of FIG. 1;

FIG. 8 is a top view of another example of a protective bar cap connect to a handle bar;

FIG. 9 is perspective view of another example of a protective bar cap;

FIG. 10 is a side view of the protective bar cap of FIG. 9;

FIG. 11 is a top view of the protective bar cap of FIG. 9;

FIG. 12 is a front view of the protective bar cap of FIG. 9;

FIG. 13 is perspective view of another example of a protective bar cap;

FIG. 14 is a top view of the protective bar cap of FIG. 13; and

FIG. 15 is a side view of the protective bar cap of FIG. 13.

### DETAILED DESCRIPTION

Various apparatuses or processes will be described below to provide an example of an embodiment of each claimed invention. No embodiment described below limits any claimed invention and any claimed invention may cover processes or apparatuses that differ from those described below. The claimed inventions are not limited to apparatuses or processes having all of the features of any one apparatus or process described below or to features common to multiple or all of the apparatuses described below. It is possible that an apparatus or process described below is not an embodiment of any claimed invention. Any invention disclosed in an apparatus or process described below that is not claimed in this document may be the subject matter of another protective instrument, for example, a continuing patent application, and the applicants, inventors, or owners do not intend to abandon, disclaim, or dedicate to the public any such invention by its disclosure in this document.

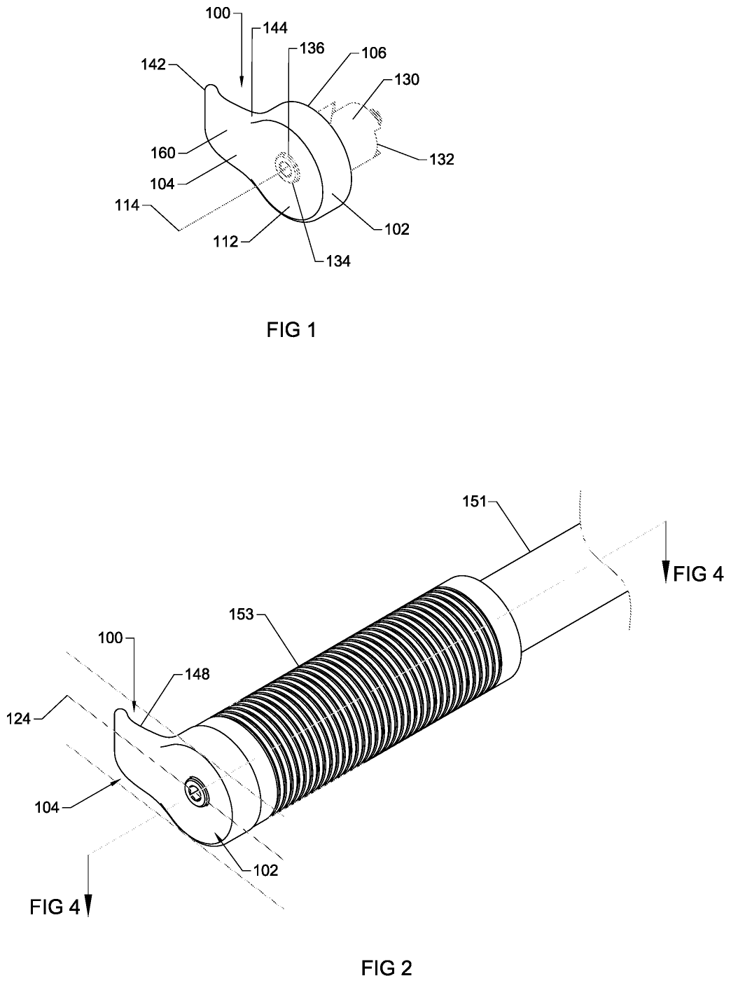

Referring to FIG. 1, one example of a protective bar cap 100 for use with the handlebar of a vehicle includes a base 102 that is connectable to the handlebar, an extending guard portion 104 that can help protect the fingers of a rider from impact.

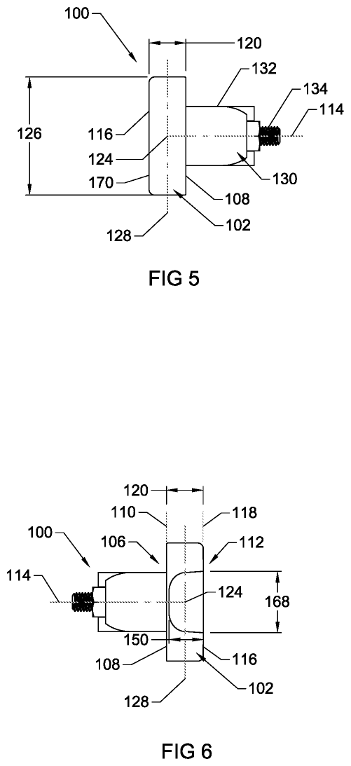

Referring also to FIG. 5-7, in this example the base 102 has an inboard side 106 that is configured to face, and preferably engage or bear against portions of the handlebar, when the cap 100 is attached to a suitable handlebar. The inboard side 106 can therefore have any suitable shape that is generally complimentary to the shape and features of a given handlebar that is to be used. In this example, the inboard side 106 includes a generally flat inner surface 108 that can abut a generally flat end of a tubular bicycle handlebar, and lies in, and helps define, an inboard plane 110. In this example, the inner surface 108 and inboard plane 110 define the inner most portion of the base 102 as described herein. In other examples the inner surface 108 may have a different shape and need not be flat.

The base 102 also includes an opposing outboard side 112 that is spaced from the inboard side 106 in a lateral direction (see axis 114). In this example the outboard side 112 includes a includes a generally flat outer surface 116 that is exposed and forms part of the outer surface of the protective bar cap 100 when in use. The outer surface 116 also lies in and helps define, an outboard plane 118. In this example, the inner surface 116 and outboard plane 118 define the outer most portion of the base 102 as described herein. In other examples the outer surface 116 may have a different shape and need not be flat.

A distance between the inboard and outboard sides 106, 112 of the base 102 in the lateral direction can define a base thickness. In the illustrated example, the base thickness 120 can be measured between the outer surface 116/outer plane 118 and the inner surface 108/inner plane 108. The base thickness 120 can be selected so that the base 102 has a desired size to fit the accompanying handlebar and so that it has the desired strength and aesthetic appearance. The base thickness 120 can, in some examples, be between 5 mm and about 30 mm, or may be between 10 mm and 25 mm, between 15 mm and 20 mm or may be other suitable sizes. Keeping the base thickness 120 less than 30 mm, 25 mm, 20 mm, 15 mm or the like may help reduce the overall increase in the lateral size of the handlebar.

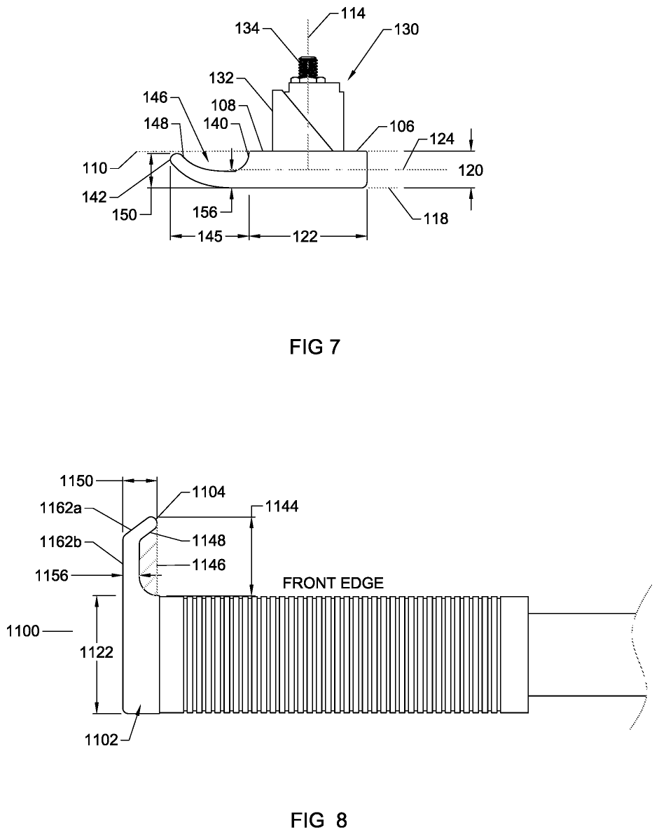

The base 102 also defines a base length 122 (FIG. 7) that is measured in a longitudinal direction (see axis 124) that is substantially orthogonal to the lateral direction/axis 114 and, in the illustrated example, can generally correspond to the front/back direction of the vehicle (and is generally horizontal as illustrated). The base length 122 can be any suitable length that is of an appropriate scale to the handlebar, and in the illustrated example can be between about 15 mm and 75 mm, and may be between 15 mm and 50 mm, or between about 25 mm and 35 mm.

Referring also to FIG. 5, the base 102 has height 126 that is measured in a third, height direction/axis 128 that is substantially orthogonal to the axes 114 and 124. This height direction is generally vertical as illustrated, and can be in the vertical, up/down direction when the protective bar cap 100 is in use. If the base 102 is generally circular in shape, as shown in this example, then the height 126 may be generally the same as the length 122. Alternatively, the height 126 can be any suitable length that is of an appropriate scale to the handlebar, and in the illustrated example can be between about 10 mm and 75 mm, and may be between 15 mm and 50 mm, or between about 20 mm and 30 mm.

To attach the protective bar cap 100 to the handlebar, it may include any suitable type of attachment or connection assembly that can connected to a compatible connection portion or mechanism on the handlebar. For example, the connection assembly may include screws or bolts that can engage threaded bores in the handlebar, friction or press-fit components, clips, threaded protrusions, insertable quill members, split clamps, grub screws and the like. In the illustrated example, the connection assembly 130 for the protective bar cap 100 includes an expandable quill portion 132 that can be inserted into the interior of handlebar, and a threaded bolt 134 that can expand the quill 132 and that passes through an aperture 136 (FIG. 1) that passes through the body 102.

Referring again to FIGS. 1, 6 and 7, the protective bar cap 100 also includes a guard portion 104 that extends longitudinally, along axis 124, from the base 102 between a guard root 140 and a guard tip 142 and defines a guard length 145. The guard length 145 is preferably between 25% and 200% of the base length 122, and may be between about 30% and about 90% of the base length 122. In this arrangement the guard portion 104 may not extend too far forward from the base 102 so it may be less likely to interfere with steering and not unduly increase the overall size of the vehicle. In some examples, the guard length 145 can be between about 10 mm and about 100 mm, and between about 15 mm and about 50 mm, and between about 20 mm and about 30 mm. Preferably, the guard length 145 can be less than 40 mm, and more preferably can be less than about 25 mm.

Preferably, the guard portion 104 is shaped to define and at least partially laterally bounds a finger recess 146 that is disposed longitudinally between the base 102 and the guard tip 142. The finger recess 146 is configured and sized so that at least a portion of finger of a vehicle rider can be at least partially laterally received within the finger recess 146 while the protective bar cap 100 is in use, but is not so large (either laterally or longitudinally) to receive or trap the hand or limb of the rider in the event of a crash, and is not positioned to overhang significant portions of the riders hand so as to pose a crush/trap risk if the guard portion 104 is deformed during a crash.

To help provide a desired finger recess 146, the guard tip 142 is positioned so as to be laterally inboard from the guard root 140, by a tip offset distance 150 that is between about 4 mm and about 15 mm, so that an inner surface 148 of the guard portion 104 is generally concave.

Preferably, the tip offset distance 150 is selected so that the guard tip 142 is disposed laterally between the inboard and outboard sides 106, 112 of the base 102. In this arrangement, the guard portion 104 is located entirely, or substantially entirely between the inboard and outboard sides 106, 112 (and planes 110 and 118). Alternatively, the tip 142 can project past the inboard side 106 (and plane 110) by an inboard offset distance 154 (see FIG. 4) that is preferably less than about 10 mm, such that the tip offset distance 150 can be greater than the base thickness 120.

Referring to FIG. 7, the root 140 of the guard portion 104 has a root width 156 in the lateral direction that can be any suitable length, and preferably is less than 20 mm, and more preferably is less 13 mm which can help provide a finger recess 146 having the desired proportions.

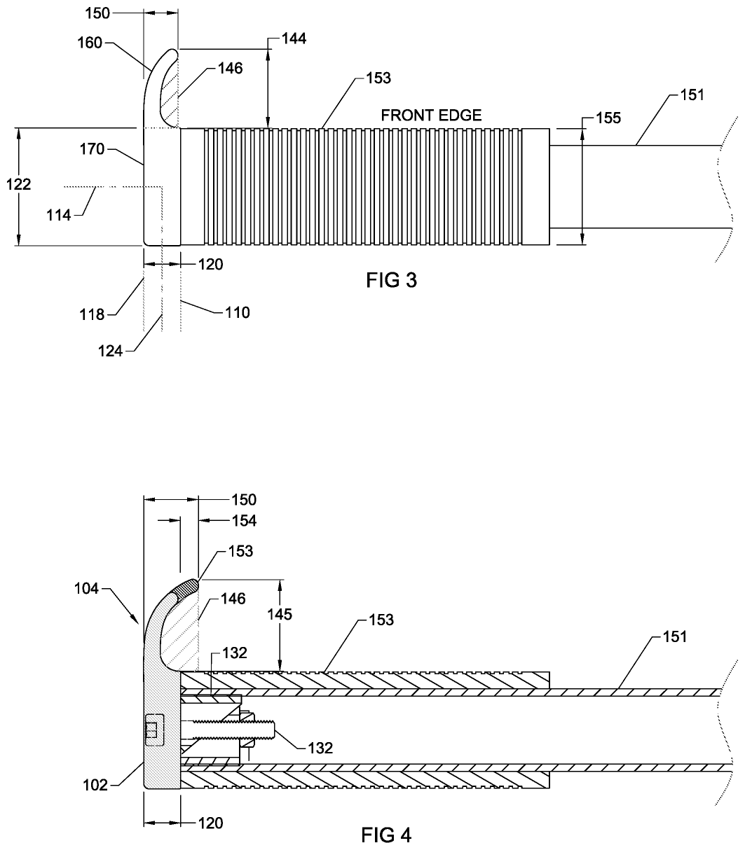

The outboard surfaces of the protective bar cap 100, and/or base 102 or guard portion 104, can be configured to include a generally continuous, surface or may include two or more separate surfaces. For example, referring to FIGS. 1 and 3 in this example an outboard face of the guard portion 104 comprises an arcuate surface 160 extending generally continuously from the guard root 140 to the guard tip 142. In other examples, such as shown in FIG. 8 (described in more detail herein) the outboard face of the guard portion 104 includes two or intersecting planar surfaces 162a and 162b.

Referring to FIGS. 2-4, the protective bar cap 100 is illustrated as being mounted onto the end of handlebar 151 that includes a hand grip 153. In this arrangement, the longitudinal axis 124 is aligned with the forward/back ward direction of the bicycle/handlebar 151, the height axis 128 is generally vertical and the lateral axis 114 is aligned with the axial direction of the end region of the handlebar 151 and hand grip 153. When connected in this manner, the protective bar cap 100 is connected to the handlebar 151 the inboard side 106 of the base engages the end of the handlebar. In this example, the portion of the handlebar 151 that is at the end of the handlebar, and is to be adjacent the protective bar cap 100, defines a bar diameter 155 (FIG. 3) that can be defined as the outer diameter of the handlebar 151 itself or of the grip 153 as shown in this example. Preferably, the base 102 is configured to generally match the size and shape of the end of the handlebar 151 and/or grip 153 and the base length 145 can be between about 80% and about 120% of the bar diameter 153.

Referring to FIG. 6, the guard portion 104 has a guard height 168, measured in the height direction along axis 128. The guard height 168 is preferably selected so that the guard portion 104 does not extend beyond the upper and lower edges of the base 102, and therefore can preferably be set a height that is less than the base height 126. This can help limit the overall size of the protective bar cap 100 and can help reduce the likelihood that the guard portion 104 will interfere with the steering or other operation of the handlebar. It may also help reduce the chances of a rider's fingers being obstructed by the guard portion 104 when grasping or releasing the grip 153. In some examples, the guard height 168 can be between about 15% and about 100% of the base height 126, and may be between about 25% and about 100% and between about 33% and 66% of the base height 126. In other examples, the guard height 168 may be equal to or greater than the base height 126, and may be between 15% and 200% of the base height or more.

In the illustrated example, the base 102 and the guard portion 104 are of integrally formed, one-piece construction. In other examples, the protective bar cap 100 may be formed from two or more separate pieces.

Referring to FIG. 8, another example of a protective bar cap 1100 is illustrated. The protective bar cap 1100 is analogous to the protective bar cap 100 with like features illustrated using like reference characters indexed by 1000. In this example, the protective bar cap 1100 includes a base 1102, having a base length 1122, and a protruding guard portion 1104 with a guard length 1140 and defining a tip offset distance 1150. The guard portion 1104 also has a general concave inner surface 1148 which helps define and bounds the finger recess 1148. In this example, instead of a single, arcuate outer surface 160 this guard portion 1104 has an outer surface that includes two, intersecting planar surfaces 1162a and 1162b.

Optionally, the outboard side 112 of the base 102 can include a substantially planar outer face 170 (FIGS. 3 and 5) that extends parallel to the longitudinal direction 124 and that can be co-planar with at least a portion of the outer face 160 (or 162a) of the guard portion 104

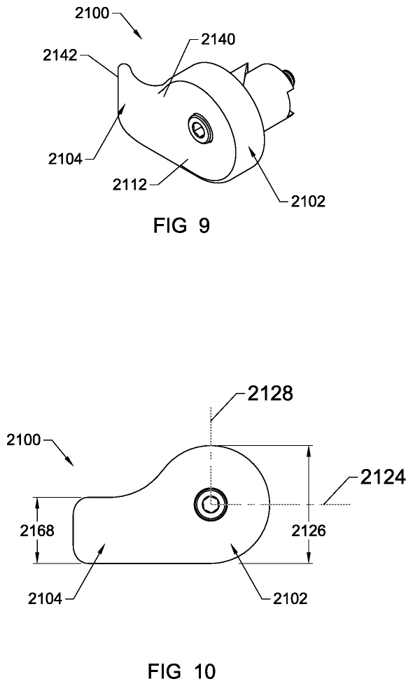

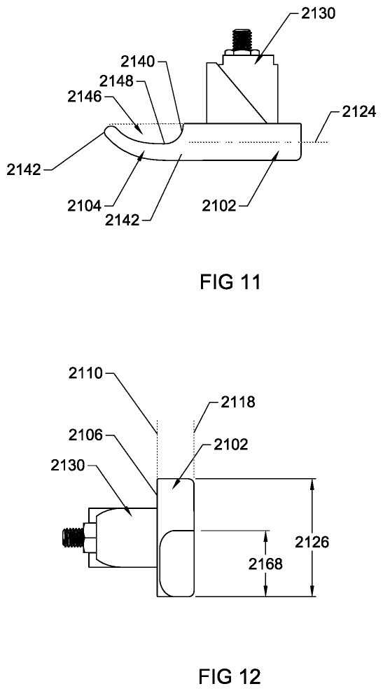

Referring to FIGS. 9-12, another example of a protective bar cap 2100 is illustrated. The protective bar cap 2100 is analogous to the protective bar cap 100 with like features illustrated using like reference characters indexed by 2000. The protective bar cap 2100 includes a base 2102 with inboard and outboard sides 2106, 2112 (with planes 2110 and 2118), a connection assembly 2130, and a guard portion 2104 that extends from the base 2102 in the longitudinal direction 2124. A finger recess 2146 is bounded by concave inner surface 2148 and disposed longitudinally between the tip 2142 and the root 2140 and base 2102.

In this example, the guard height 2168 is less than the base height 2126 and the guard portion 2104 is arranged such that it not centered in the height direction 2128 and instead is offset toward the lower side of the base 2102 as illustrated (which may be either the lower or upper side of the protective bar cap 2100 when it is connected to a handlebar).

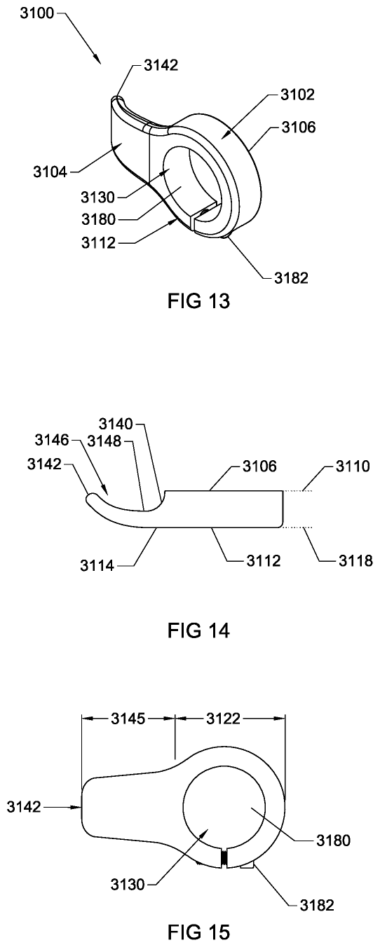

Referring to FIGS. 13-15, another example of a protective bar cap 3100 is illustrated. The protective bar cap 3100 is analogous to the protective bar cap 100 with like features illustrated using like reference characters indexed by 3000. The protective bar cap 3100 includes a base 23102 with inboard and outboard sides 3106, 3112 (with planes 3110 and 3118), a connection assembly 3130, and a guard portion 3104 that extends from the base 3102 in the longitudinal direction 3124. A finger recess 3146 is bounded by concave inner surface 3148 and disposed longitudinally between the tip 3142 and the root 3140 and base 3102. In this example, the guard length 3145 is less than the base length 3122.

In this example, the base 3102 is configured such that connection assembly 3130 includes relatively large central aperture 3180 that is sized to fit around the outer surface of the handlebar or grip to which the protective bar cap 3100 is to be attached. The base 3102 can flex sufficiently, and preferably resiliently, such that tightening or loosening the fastening bolt 3182 can secure and loosen the protective bar cap 3100, respectively.

As used herein, the term “about” means that differences to any of the specified dimensions that do not materially affect the function or operation the protective bar cap as described herein would be understood by a person skilled in the art to be included in the specified ranges, dimensions, etc. For example, specifying that a distance is less than about 25 mm would be understood to allow for minor variations in the that distance as a result of manufacturing tolerances and the like, as well as intending to cover immaterial differences, such as if a competing part were manufactured with a corresponding distance that was 25.5 mm or 26 mm or 27 mm, for example. Therefore, “about” can be considered to include values that are +/− about 15% of the stated dimension, which practically may be +/− a few millimetres in the embodiments described herein.

While this invention has been described with reference to illustrative embodiments and examples, the description is not intended to be construed in a limiting sense. Thus, various modifications of the illustrative embodiments, as well as other embodiments of the invention, will be apparent to persons skilled in the art upon reference to this description. It is therefore contemplated that the appended claims will cover any such modifications or embodiments.

All publications, patents and patent applications referred to herein are incorporated by reference in their entirety to the same extent as if each individual publication, patent, or patent application was specifically and individually indicated to be incorporated by reference in its entirety.

What is claimed is:

1. A protective bar cap that is connectable to a handlebar of a vehicle, the protective bar cap comprising:
a) a base that is connectable to an end of a handlebar of a vehicle and comprises an inboard side, an opposing outboard side that is spaced from the inboard side in a lateral direction, and a base length in a longitudinal direction that is orthogonal to the lateral direction;
b) a guard portion extending longitudinally from the base between a guard root and a guard tip and defining a guard length that is between 25% and 200% of the base length, the guard tip being positioned laterally inboard from the guard root so that an inner surface of the guard portion is generally concave and laterally bounds a finger recess that is disposed longitudinally between the base and the guard tip;
wherein when the protective bar cap is connected to the handlebar the inboard side of the base engages the end of the handlebar and a finger of a vehicle rider can be at least partially laterally received within the finger recess.

2. The protective bar cap of claim 1, wherein the guard tip is disposed laterally between the inboard and outboard sides of the base.

3. The protective bar cap of claim 1, wherein the guard tip is laterally offset from the guard root by a tip offset distance that is between about 4 mm and about 15 mm

4. The protective bar cap of claim 1, wherein the guard tip is disposed laterally inboard of the inboard side of the base by an inboard offset distance that is less than about 10 mm.

5. The protective bar cap of claim 1, wherein a lateral distance between the inboard and outboard sides of the base defines a base thickness and is between about 5 mm and about 30 mm.

6. The protective bar cap of claim 1, wherein the guard length is between about 30% and about 90% of the base length.

7. The protective bar cap of claim 1, wherein the guard length is less than 40 mm.

8. The protective bar cap of claim 7, wherein the guard length is less than 25 mm.

9. The protective bar cap of claim 1, wherein the root of the guard portion has a root thickness in the lateral direction that is less than 20 mm.

10. The protective bar cap of claim 9, wherein the root thickness is less 13 mm.

11. The protective bar cap of claim 1, wherein an outboard face of the guard portion comprises an arcuate surface extending generally continuously from the guard root to the guard tip.

12. The protective bar cap of claim 1, wherein an outboard face of the guard portion comprises two or more intersecting planar surfaces.

13. The protective bar cap of claim 1, wherein the base and the guard portion are of integrally formed, one-piece construction.

14. The protective bar cap of claim 1, wherein the end of the handlebar has a bar diameter and the base length is between about 80% and about 120% of the bar diameter.

15. The protective bar cap of claim 1, wherein the base has a base height in a third direction that is orthogonal to the lateral and longitudinal directions, and wherein the guard portion has a guard height in the third direction that is between 15% and 200% of the base height.

16. The protective bar cap of claim 15, wherein the guard height is between 25% and 100% of the base height.

17. The protective bar cap of claim 1, wherein the outboard side of the base includes a substantially planar outer face that extends parallel to the longitudinal direction.

18. The protective bar cap of claim 15, wherein the substantially planar outer face is co-planar with at least a portion of an outer face of the guard portion.
